(19) United States
(12) Patent Application Publication
(10) Pub. No.: US 2026/0300081 A1
(43) Pub. Date: Oct. 1, 2026

(54) NATURAL LANGUAGE PROCESSING-BASED SELF-OPTIMIZATION OF COMMUNICATIONS NETWORKS

(71) Applicant: AT&T Intellectual Property I, L.P., Atlanta, GA (US)

(72) Inventors: Nishan Singh, Freehold, NJ (US); Kulbhusan Azad, Sayreville, NJ (US); Ayush Kumar, East Brunswick, NJ (US); Abdulla Udaipurwala, Monroe, NJ (US)

(21) Appl. No.: 19/097,736

(22) Filed: Apr. 1, 2025

(51) Int. Cl. G06F 11/07; G06F 8/65

(52) U.S. Cl. CPC G06F 11/0793; G06F 8/65; G06F 11/0709

(57) ABSTRACT

A method for natural language processing-based self-optimization of communications networks includes identifying, using natural language processing, a contextual impact of a change to a software application on a communications network in which the software application is deployed, predicting, using a machine learning model, a magnitude of the contextual impact, determining, based on a nature of the contextual impact and the magnitude of the contextual impact, a remedial action to mitigate the magnitude of the contextual impact, and taking an action to deploy the remedial action in the communications network.

The present disclosure relates generally to communications networks and relates more particularly to devices, non-transitory computer-readable media, and methods for natural language processing-based self-optimization of communications networks.

### BACKGROUND

Many large enterprises span multiple functions which each possess a unique collection of applications. For instance, for an enterprise that operates a communications network such as a cellular network, these applications may include layer 1, layer 2, and layer 3 functions for enterprise Internet, virtual private network (VPN), fiber broadband, and mobility services. The stacks for these functions may in turn comprise a variety of software tools, technologies, and libraries.

### SUMMARY

In one example, the present disclosure describes a device, computer-readable medium, and method for natural language processing-based self-optimization of communications networks. For instance, in one example, a method performed by a processing system including at least one processor includes identifying, using natural language processing, a contextual impact of a change to a software application on a communications network in which the software application is deployed, predicting, using a machine learning model, a magnitude of the contextual impact, determining, based on a nature of the contextual impact and the magnitude of the contextual impact, a remedial action to mitigate the magnitude of the contextual impact, and taking an action to deploy the remedial action in the communications network.

In another example, a non-transitory computer-readable medium stores instructions which, when executed by a processor, cause the processor to perform operations. The operations include identifying, using natural language processing, a contextual impact of a change to a software application on a communications network in which the software application is deployed, predicting, using a machine learning model, a magnitude of the contextual impact, determining, based on a nature of the contextual impact and the magnitude of the contextual impact, a remedial action to mitigate the magnitude of the contextual impact, and taking an action to deploy the remedial action in the communications network.

In another example, a device includes a processor and a computer-readable medium storing instructions which, when executed by the processor, cause the processor to perform operations. The operations include identifying, using natural language processing, a contextual impact of a change to a software application on a communications network in which the software application is deployed, predicting, using a machine learning model, a magnitude of the contextual impact, determining, based on a nature of the contextual impact and the magnitude of the contextual impact, a remedial action to mitigate the magnitude of the contextual impact, and taking an action to deploy the remedial action in the communications network.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a block diagram of an example natural language processing pipeline and its operations, in accordance with the present disclosure;

FIG. 3 illustrates a flowchart of an example method for self-optimizing a communications network using natural language processing-based, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides natural language processing-based self-optimization of communications networks. As discussed above, many large enterprises span multiple functions which each possess a unique collection of applications. For instance, for an enterprise that operates a communications network such as a cellular network, these applications may include layer 1, layer 2, and layer 3 functions for enterprise Internet, virtual private network (VPN), fiber broadband, and mobility services. The stacks for these functions may in turn comprise a variety of software tools, technologies, and libraries.

The versions of these software tools, technologies, and libraries may vary across teams, depending upon several factors related to application function and usage. Communications networks are also evolving toward software defined networking, which results in an increased dependency of the networks on third-party software. Significant interdependency exists between network operating systems (NOS) provided by vendors and the services (e.g., AT&T Dynamic Defense, dedicated Internet, Ethernet, fiber broadband, mobility, and the like) defined by a communications network operator via operation support system as a service (OSSaS). At present, when an upgrade or change occurs on either side (e.g., vendor side or OSS provider side), a significant amount of time and analysis may be spent identifying the impacts of the change and certifying the change on either side. Even so, leakage of defects leading to catastrophic network outages may still occur.

Current software development cycles periodically ensure alignment with the newest versions of dependencies in one or more of a variety of ways, including: careful study of the release notes of the new version (often performed manually), analysis of existing artifacts (e.g., code, schema, and the like) to identify references, installation of the new version, incorporation of initially identified changes, incorporation of additional missed changes during a later phase of the development cycle (e.g., testing or production), and/or periodic checking for the availability of new versions and accommodation of changes. However, keeping up to date with the newest versions of the dependencies also involves many challenges, including static and/or suboptimal impact analysis (e.g., due to lack of developer expertise), delayed adoption of new features (which may, in turn, lead to exposure to security risks), human error (e.g., overlooking details), lack of availability of test environments and developers, necessity of separate impact analyses per consumer application, and inconsistencies across systems.

Examples of the present disclosure utilize natural language processing (NLP) to identify dependencies between network operating systems and specialized services defined via OSSaS, to identify and predict the magnitudes of any impacts of a software change on the NOS or service side, to categorize and summarize the impacts, and to mitigate the effects of the impacts before those effects can negatively impact the performance of the network.

The disclosed approach provides a comprehensive view of a software change’s contextual impact, offering insights into how the change affects a broader enterprise system (e.g., a communications network). This depth of analysis ensures that decisions are made with a full understanding of the implications of those decisions, which may lead to more informed and effective upgrade strategies.

Moreover, thorough and unbiased visibility into the impact analysis may lead to a higher level of efficiency and accuracy by providing a more precise understanding of how an upgraded or changed software application interacts with existing systems and meticulously noting any changes (as well as the potential effects of these changes). Methodically detailing these changes may enhance the accuracy of the software upgrade process.

Self-optimization according to examples of the present disclosure also provides an opportunity to incorporate optimization according to industry standards and to incorporate best practices. Moreover, self-optimization allows for the systematic evaluation of current procedures and the integration of improvements, which may lead to enhanced performance and streamlined operations. Software upgrades may be implemented in a consistent manner with little to no human error affecting the outcome. Moreover, the costs of implementing software upgrades may be reduced by reducing the reliance on manual interventions.

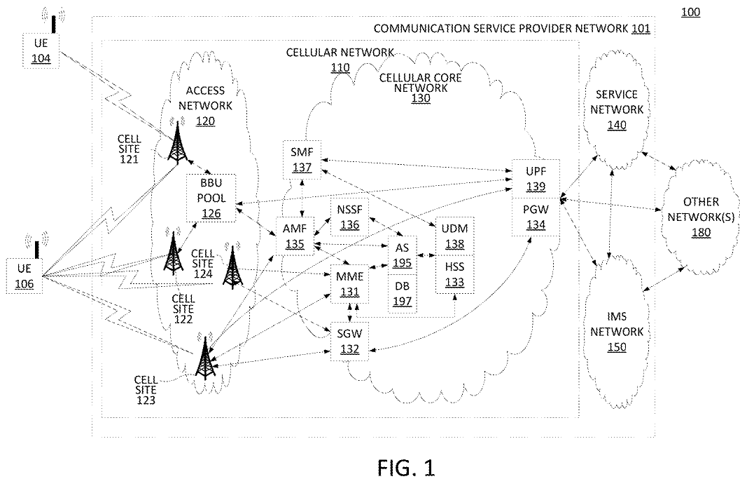

The disclosed NLP-based self-optimization technique can therefore minimize the risk of network outages and enhance the reliability and continuity of the network service experienced by customers. Moreover, although examples of the present disclosure may be described below in the context of communications network operations, it will be appreciated that software upgrade processes are not confined to communications network operations. The techniques disclosed herein may be equally applicable to other industries that rely on the interoperation of hardware and software provided by various third parties. These and other aspects of the present disclosure are discussed in greater detail in connection with FIGS. 1-4, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a radio access network (RAN), such as a cloud RAN, a distributed RAN (D-RAN), a centralized RAN (C-RAN), a virtualized RAN (V-RAN), or an open RAN (O-RAN). For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU. In accordance with the present disclosure, any one or more of cell sites 121-123 may be deployed with antenna and radio infrastructures, including MIMO and millimeter wave antennas

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across an LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and/or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, an item of customer premises equipment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

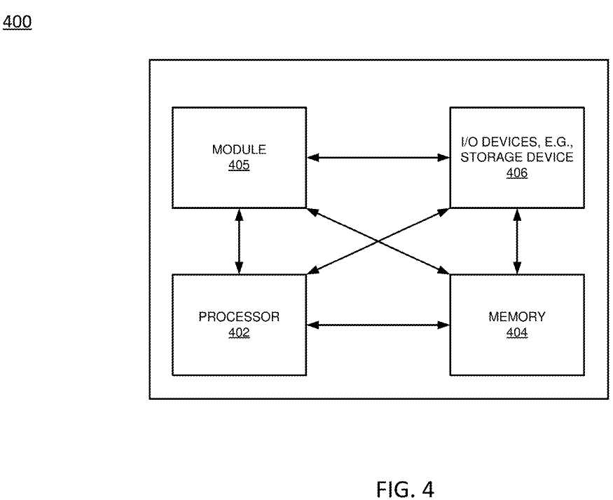

In one example, each of the UEs 104 and 106 may comprise all or a portion of a computing system, such as computing system 400 depicted in FIG. 4, and may be configured to perform steps, functions, and/or operations in connection with examples of the present disclosure for natural language processing-based self-optimization of communications networks. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, the cellular core network 130 may further include an application server (AS) 195, which may comprise a computing system or server, such as computing system 400 depicted in FIG. 4, and may be configured to provide one or more operations or functions in connection with examples of the present disclosure for natural language processing-based self-optimization of communications networks. The cellular core network 130 may also include a database (DB) 197 that is communicatively coupled to the AS 195.

The AS 195 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

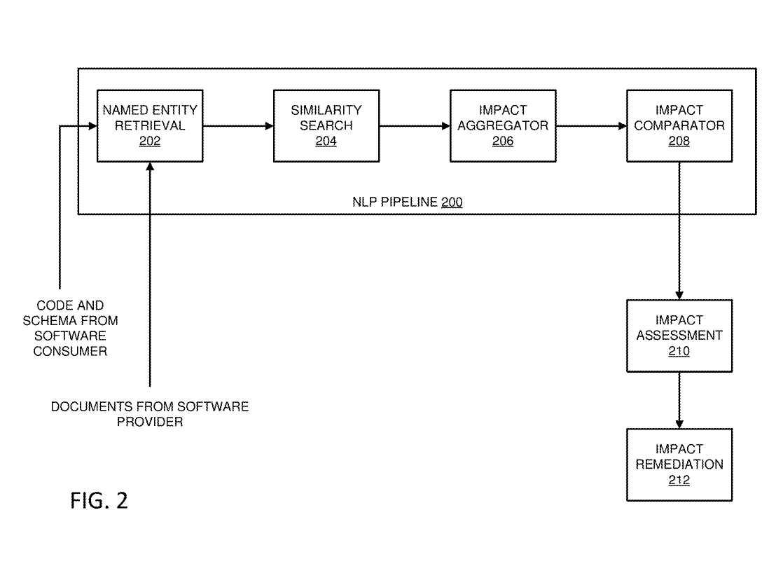

In one example, the AS 195 may be configured to perform self-optimization of the communication service provider network 101 using natural language processing. For instance, in some examples, the AS 195 may execute a natural language processing pipeline (an example of which is illustrated in FIG. 2) that analyzes changes (e.g., upgrades and/or other changes) to a software application running in the communication service provider network 101 and quantifies an impact of those changes on operations of the communication service provider network 101.

For instance, the AS 195 may extract named entities (e.g., functions, code blocks, and the like) from inputs provided by both the consumer of the software application (e.g., in the example of FIG. 1, the operator of the communication service provider network 101) and the provider of the software application. These inputs may include code and schema for a currently deployed version of the software application (e.g., retrieved from the consumer side), as well as documents related to the change to the software application (e.g., retrieved from the provider side, and potentially including release notes, articles, frequently asked questions, best practices, and/or other documentation). These named entities may be matched to entries for functions in a release library associated with the change to the software application and compared to those entries to quantify a magnitude of the impact of the change to the software application on the operations of the communication service provider network 101. Depending upon the magnitude of the impact, the AS 195 may carry out one or more remediating actions to minimize the impact, such as deploying code patches, refactoring codebases for the software application, or the like.

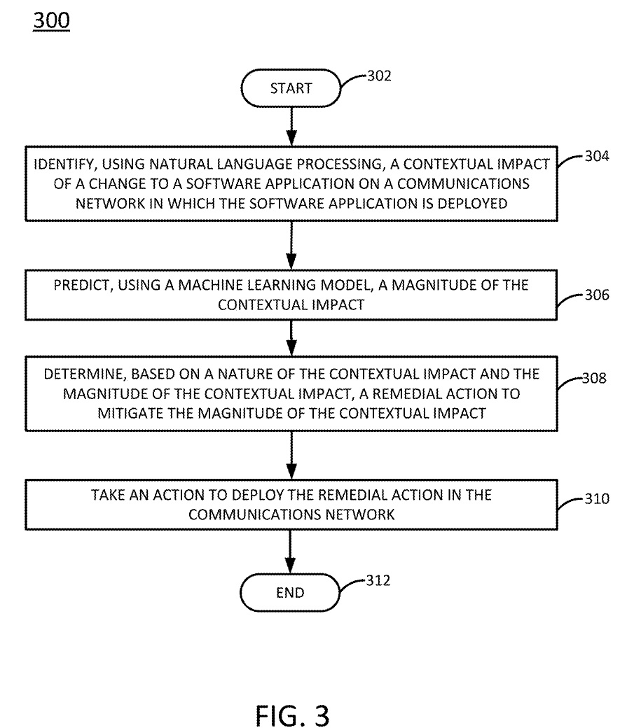

The DB 197 may store documents related to various versions or releases of the software application, including release libraries. In one example, the DB 197 may comprise a physical storage device integrated with the AS 195 (e.g., a database server or a file server), or attached or coupled to the AS 195, in accordance with the present disclosure. In one example, the AS 195 may load instructions into a memory, or one or more distributed memory units, and execute the instructions for natural language processing-based self-optimization of communications networks, as described herein. An example method for natural language processing-based self-optimization of communications networks is described in greater detail below in connection with FIG. 3.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-124 may comprise 2G, 3G, 4G and/or LTE radios, e.g., in addition to 5G new radio (NR), or gNB functionality, or any future cellular technology, e.g., 6G and so on. For instance, cell site 123 is illustrated as being in communication with AMF 135 in addition to MME 131 and SGW 132. Thus, these and other modifications are all contemplated within the scope of the present disclosure.

FIG. 2 illustrates a block diagram of an example natural language processing (NLP) pipeline 200 and its operations, in accordance with the present disclosure. The NLP pipeline 200 may comprise a plurality of NLP agents which may be executed by a processing system or application server (e.g., AS 195 of FIG. 1, processor 402 of FIG. 4, or the like). The NLP pipeline 200 may facilitate analysis and remediation of the impact of a change to a software application on the operations of an enterprise that utilizes the software application, such as a communications network.

As illustrated in FIG. 2, to properly analyze the impact of a change to a software application, the NLP pipeline 200 may ingest inputs from both the software provider side and the software consumer side. From the software provider side, the inputs may include documents related to the software application, including documents related to the change to the software application (e.g., documents related to the most recent release of the software application). These documents may include, for instance, release notes, articles, frequently asked questions, best practices documents, and/or other documents. From the software consumer side, the inputs may include information about the code and schema of the software application as the software application is deployed.

In one example, the NLP pipeline 200 may comprise a plurality of NLP agents, including a named entity retrieval agent 202, a similarity search agent 204, an impact aggregator agent 206, and an impact comparator agent 208. The named entity retrieval agent 202 may extract named entities from the inputs that are acquired from the software provider side and the software consumer side. In one example, these named entities may include functions, code blocks, and/or other entities.

The similarity search agent 204 may match any named entities extracted by the named entity retrieval agent 202 to entries (e.g., functions) in the release library for the software application. This will help the NLP pipeline 200 to determine, for instance, whether any functions or code blocks extracted from the inputs are present in the most recent release of the software application. If any functions or code blocks extracted from the inputs are present in the most recent release of the software application, then the new release of the software application is likely to have an impact (e.g., to cause changes) on the software consumer side. Thus, the similarity search agent 204 allows the NLP pipeline 200 to identify portions of the code of the software application that will be impacted by the new release of the software application. In one example, the similarity search agent 204 may calculate, for each named entity that is matched to an entry in the release library, a value that represents a magnitude of the difference between the named entity in the version of the software application currently being used on the consumer side and the named entity in the new release of the software application. In one example, the value may comprise a cosine similarity value.

The impact aggregator agent 206 may aggregate all of the values calculated by the similarity search agent 204 into a single value that represents the overall impact of the change to the software application (e.g., the impact of the software consumer upgrading to the most recent release of the software application).

The impact comparator agent 208 may quantify a magnitude of the impact of the change to the software application, based on the single value that is calculated by the impact aggregator agent 206. For instance, in some cases, even though there is a change to the software application, the impact on the enterprise that consumes the software application (e.g., a communications network) may be relatively minimal. However, in other examples, the magnitude of the impact may be much greater.

Once the NLP pipeline 200 has quantified a magnitude of the impact of the change to the software application, an impact assessment agent 210 (which may comprise an NLP agent separate from the NLP pipeline 200) may determine whether the magnitude of the impact is great enough that a remediating action is necessary to minimize the impact. For instance, in one example, if the magnitude of the impact is greater than a threshold magnitude, then the impact assessment agent 210 may determine that a remediating action is necessary. If, however, the magnitude of the impact is not greater than the threshold magnitude, then the impact assessment agent 210 may determine that a remediating action is not necessary.

If the impact assessment agent determines that a remediating action is necessary to minimize the impact of the change to the software application, then an impact remediation agent 212 (which may comprise an NLP agent separate from the NLP pipeline 200) may be engaged. The impact remediation agent 212 may select and carrying out a remediating action to minimize the impact of the change to the software application. The remediating action may include, for example, generating and deploying a code patch, refactoring a codebase to incorporate a recommended change, and/or another action.

To further aid in understanding the present disclosure, FIG. 3 illustrates a flowchart of an example method 300 for self-optimizing a communications network using natural language processing-based, in accordance with the present disclosure. The method 300 may be performed when a new version or release of a software application is made available, or when documentation related to the new version or release is made available. In one example, the method 300 may be performed by an application server that is capable of optimizing a communications network, such as the AS 195 illustrated in FIG. 1, or by an NLP pipeline, such as the NLP pipeline 200 illustrated in FIG. 2. However, in other examples, the method 300 may be performed by another device, such as the processor 402 of the system 400 illustrated in FIG. 4 (where the system 400 may be part of an AS, an NLP pipeline, or another device). For the sake of example, the method 300 is described as being performed by a processing system.

The method 300 begins in step 302. In step 304, the processing system may identify, using natural language processing, a contextual impact of a change to a software application on a communications network in which the software application is deployed.

In one example, the communications network may comprise a telecommunications network that utilizes network operating systems provided by a plurality of different vendors. These network operating systems may operate in an interdependent manner with the various services provided via the telecommunications network (which may include, for example, SANE, ADI, Ethernet, fiber broadband, mobility, and other services). In one example, the various services may be defined by an operator of the telecommunications network via OSSaS. The software application may comprise a third-party NOS-side software application or a third party service-side software application. The change to the software application may comprise a software upgrade or update (e.g., a patch or a new version release) or a different type of change to the software application (e.g., a new functionality).

In one example, NLP may be used to analyze the features and functionalities of a third-party library that is used by the software application. From this analysis, the processing system may be able to identify the contextual impact of the change to the software application.

For instance, the processing system may acquire documents related to the most recent release of the software application (e.g., the release including the change), where the documents may include release notes, articles, frequently asked questions, best practices, and other documents. The processing system may also acquire code and schema from an application in the communications network that relies on the software application. The processing system may then utilize a first NLP technique or agent to detect and extract named entities (e.g., functions, code blocks, and the like) from the documents, code, and schema. Once the named entities have been extracted, the processing system may utilize a second NLP technique or agent to match the extracted named entities to release library information for the most recent release of the software application. Once a match has been made between an extracted named entity and an entity in the release library, the processing system may utilize a third NLP technique or agent to determine similarity values for matched entities and to aggregate all of the similarity values across the most recent release of the software application and the immediately previous release of the software application. The processing system may then utilize a fourth NLP technique or agent to determine the nature of the impact based on the aggregated similarity values.

In step 306, the processing system may predict, using a machine learning model, a magnitude of the contextual impact.

In one example, the machine learning model may receive as inputs a variety of factors related to the communications network, the software application, the change to the software application, and the impact of the change, and may generate as an output a prediction of the severity of the magnitude of the impact. In one example, the factors received as inputs may include one or more of: a centrality of the features of the software application that are affected by the change to the core functionality of the software application, a complexity of implementing a workaround to offset the contextual impact, and a potential for performance degradation of the communications network as a result of the contextual impact.

In one example, the machine learning model predicts the magnitude of the contextual impact as one of a set of fixed choices indicating varying levels of the severity of the magnitude (e.g., low/medium/high). In another example, the machine learning model predicts the magnitude of the contextual impact on a numerical scale (e.g., 1-10, where 1 indicates a lowest severity and 10 indicates a highest severity).

In step 308, the processing system may determine, based on a nature of the contextual impact and the magnitude of the contextual impact, a remedial action to mitigate the magnitude of the contextual impact.

In one example, the nature of the remedial action may vary depending upon the nature and magnitude of the contextual impact. For instance, the remedial action may include implementing a minor code change in the communications network, implementing an architectural change in the communications network (e.g., deploying new instances of hardware or virtual machines, removing existing instances of hardware or virtual machines, deploying new links between hardware or virtual machines, removing existing links between hardware or virtual machines, or the like), or other types of remedial actions.

In one example, a machine learning model (different from the machine learning model used to predict the magnitude of the contextual impact) may be used to generate a suggested remedial action based on the nature and magnitude of the contextual impact as well as the topography of the communications network. In one example, the machine learning model may generate a plurality of recommended remedial actions, each of which may be associated with a respective confidence score indicating a predicted effectiveness of the remedial action. The plurality of recommended remedial actions may then be ranked according to the predicted effectiveness, so that the recommended remedial actions that are most likely to be most effective can be easily identified.

In one example, the machine learning model may utilize one or more code generation models that have been trained on large corpuses of programming languages and patterns to produce high-quality, easily maintainable code.

In step 310, the processing system may take an action to deploy the remedial action in the communications network.

In one example, taking the action in step 310 may involve the processing system generating a code patch and delivering the code patch to a network entity (e.g., a NOS, a software application, a hardware component, or the like) along with an instruction to install the code patch. In another example, taking the action in step 310 may involve the processing system refactoring a codebase to incorporate a code change that is part of the remedial action.

In another example, the processing system may integrate the remedial action into a continuous integration and continuous delivery (CI/CD) pipeline for the communications network, which may help to ensure that the remedial action is applied and tested in an automated and efficient manner.

The method 300 may end in step 312.

Although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIGS. 1 or 2 or described in connection with the method 300 may be implemented as the system 400. For instance, an application server or NLP pipeline (such as might be used to perform the method 300) could be implemented as illustrated in FIG. 4.

As depicted in FIG. 4, the system 400 comprises a hardware processor element 402, a memory 404, a module 405 for natural language processing-based self-optimization of communications networks, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for natural language processing-based self-optimization of communications networks may include circuitry and/or logic for translating wireless specifications documents and/or wireless network event logs into finite state machines. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for natural language processing-based self-optimization of communications networks (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for natural language processing-based self-optimization of communications networks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
identifying, by a processing system including at least one processor and using natural language processing, a contextual impact of a change to a software application on a communications network in which the software application is deployed;
predicting, by the processing system using a machine learning model, a magnitude of the contextual impact;
determining, by the processing system based on a nature of the contextual impact and the magnitude of the contextual impact, a remedial action to mitigate the magnitude of the contextual impact; and
taking, by the processing system, an action to deploy the remedial action in the communications network.

2. The method of claim 1, wherein the communications network comprises a telecommunications network that utilizes network operating systems provided by a plurality of different vendors which operate in an interdependent manner with a plurality of services provided via the telecommunications network.

3. The method of claim 2, wherein the software application comprises a third-party network operating system-side software application.

4. The method of claim 3, wherein the change comprises at least one of: an update to the software application or an upgrade to the software application.

5. The method of claim 1, wherein the identifying comprises extracting a named entity from an input provided by at least one of: an operator of the communications network or a provider of the software application, and determining a difference between the named entity and an entry in a release library of the software application for a function that matches the named entity.

6. The method of claim 5, wherein the input is derived from a document provided by the provider of the software application.

7. The method of claim 6, wherein the document is at least one of: a release note for a new release of the software application, an article about the new release of the software application, a frequently asked questions document for the new release of the software application, or a best practices document for the new release of the software application.

8. The method of claim 5, wherein the input is derived from at least one of: code for a version of the software application that is currently deployed in the communications network or schema for the version of the software application that is currently deployed in the communications network.

9. The method of claim 5, wherein the named entity comprises at least one of: a function or a code block.

10. The method of claim 5, wherein the predicting comprises aggregating, for all named entities that are extracted, values that quantify differences between the all named entities and corresponding functions in the release library.

11. The method of claim 10, wherein each difference of the differences further accounts for at least one of: a centrality of a corresponding named entity of the all named entities to a core functionality of the software application, a complexity of implementing a workaround to offset the contextual impact, or a potential for performance degradation of the communications network as a result of the contextual impact.

12. The method of claim 1, wherein the magnitude is expressed as a selection of a severity level from among a fixed set of varying severity levels.

13. The method of claim 1, wherein the remedial action comprises at least one of: implementing a code change in the communications network or implementing an architectural change in the communications network.

14. The method of claim 13, wherein the processing system utilizes a code generation model to generate the code change.

15. The method of claim 1, wherein the taking the action comprises generating a code patch and delivering the code patch to at least one of: a network operating system in the communications network, a software application in the communications network, or a hardware component in the communications network.

16. The method of claim 1, wherein the taking the action comprises refactoring a codebase of the communications network to incorporate a code change.

17. The method of claim 1, wherein the taking the action comprises integrating the remedial action into a continuous integration and continuous delivery pipeline for the communications network.

18. The method of claim 1, wherein at least the identifying and the predicting are performed by executing a pipeline of natural language processing agents.

19. A non-transitory computer-readable medium storing instructions which, when executed by a processing system including at least one processor, cause the processing system to perform operations, the operations comprising:
identifying, using natural language processing, a contextual impact of a change to a software application on a communications network in which the software application is deployed;
predicting, using a machine learning model, a magnitude of the contextual impact;
determining, based on a nature of the contextual impact and the magnitude of the contextual impact, a remedial action to mitigate the magnitude of the contextual impact; and
taking an action to deploy the remedial action in the communications network.

20. A device comprising:
a processing system including at least one processor; and
a computer-readable medium storing instructions which, when executed by the processing system, cause the processing system to perform operations, the operations comprising:
identifying, using natural language processing, a contextual impact of a change to a software application on a communications network in which the software application is deployed;
predicting, using a machine learning model, a magnitude of the contextual impact;
determining, based on a nature of the contextual impact and the magnitude of the contextual impact, a remedial action to mitigate the magnitude of the contextual impact; and
taking an action to deploy the remedial action in the communications network.
